(19) United States
(12) Patent Application Publication
(10) Pub. No.: US 2004/0074214 A1
(43) Pub. Date: Apr. 22, 2004

(54) Filter housing

(76) Inventor: Joseph C. Henson, Fort Washington, MD (US)

Correspondence Address: Michael J. Foycik, Jr., 1718 M St. N.W., #255, Washington, DC, 20036, US

(21) Appl. No.: 10/607,540

(22) Filed: Jun. 27, 2003

Related U.S. Application Data
(60) Provisional application No. 60/392,056, filed on Jun. 28, 2002.

(51) Int. Cl. B01D 46/00

(52) U.S. Cl. 55/501; 55/506

(57) ABSTRACT

An air filter housing slidably receives an air filter therein, without requiring the air filter housing to be removed from the wall, floor or ceiling surrounding an air duct. The air filter housing varies in size in at least one dimension, to reduce the quantity of air filters and air filter housing required to accommodate a wide variety of air duct types and sizes. The air filter housing is mounted to a register, diffuser or return air grill covering an air duct. The air filter is slidably received in the air filter housing, for ease of removing, cleaning or replacing the air filter. The air filter housing is adaptable to receive a variety of air filters which are custom designed to remove specific pollutants from the air, to improve the air quality in a home or office.

### CROSS REFERENCE TO RELATED APPLICATIONS

This application is a continuation-in-part of provisional application No. 60/392,056, filed on Jun. 28, 2002 entitled “Filter Housing” in the name of Mr. Joseph C. Henson, and this application hereby claims the priority of that application and incorporates same in its entirety by reference herein.

### BACKGROUND OF THE INVENTION

1. Field of the Invention

The present invention relates to a filter housing for a register, diffuser, or return air grill. More particularly, the present invention relates to a filter housing which can be placed over an existing register, diffuser or return air grill, and wherein the filter is inserted between the grill and the filter housing from one side, eliminating the need to open or remove the filter housing or the grill to replace the filter.

2. Background of the Invention

The benefits of air filters to remove dust, pollen, and impurities from circulating air within a building are well recognized in the art. Air filters are commonly used in proximity to heaters and air conditioning units. The filtered air is typically routed through air ducts to various locations within a building, such as a home or office. It is well known that dust, pollen and other air impurities accumulate in the air delivery ducts. Thus, the filtered air is contaminated by the air impurities in the air delivery ducts, prior to being circulated in a room located in a building, such as a home or an office.

To overcome this difficulty, prior art air filters have been mounted in the air duct beneath the grill. To accomplish this, the air duct grill must be removed in order to replace the air filter. Since these air filters need to be periodically replaced or cleaned to operate efficiently, the air duct grill must be removed and reinstalled, each time the air filter is cleaned or replaced. With the filter positioned behind the grill register, it is difficult to visually determine when the filter needs changing. Prior art devices require the grill must be removed to inspect the filter, in order to determine when the filter needs changing. This is time consuming, and labor intensive.

Other attempts to overcome these difficulties include grills that slide, pivot or hinge to receive the air filter. This increases the complexity of the air filter housing, increases costs, and requires a large inventory of air filters and air filter housings to fit the many sizes of air ducts found in homes and offices.

Thus, many sizes of air filters and air filter housings must be manufactured, transported and sold, in order to accommodate the need for various sizes of air ducts. This requires additional storage and shelf space, as well as creating confusion as to which size of air filter and air filter housing are required for each air duct in a home or office.

Examples of prior art air filter housings known in the art, include:

U.S. Pat. No. 5,947,815 issuing to Danforth on Sep. 7, 1999. This invention discloses an air register filtering system having a frame, with an air filter enclosed within the frame. A top cover is hinged to the frame, and must be opened, to access the air filter.

U.S. Pat. No. 5,863,310 issuing to Barbara Brown on Jan. 26, 1999, discloses a grill/filter mounting assembly, where the grill is hinged to the duct, and must be sized to fit an existing duct.

U.S. Pat. No. 5,792,230 issuing to Glenn Moore et al. On Aug. 11, 1998, discloses an air register having a filter element. A pivotable retaining plate engages the face plate to retain the filter across the openings of the register.

U.S. Pat. No. 4,344,899 issuing to Paul McConnell on Jun. 15, 1982, discloses a snap on air duct filter assembly having first and second frames.

U.S. Pat. No. 2,575,499 issuing to M. Manow on Nov. 20, 1951 discloses a slide-in fiber glass filter received in a hinged housing sized to fit an air duct.

U.S. Pat. No. 1,914,397 issuing to Bender on Jun. 20, 1933, discloses a dust shield for warm air registers. This patent teaches a dust shield held in a securing means above a register.

U.S. Pat. No. 1,801,794 issuing to C. Broudy et al. On Apr. 21, 1931 discloses a register filter secured to a hot air register.

U.S. Pat. No. 1,726,792 issuing to F. Altman et al. on Sep. 3, 1929 discloses an adjustable register screen pivoted to a frame.

U.S. Pat. No. 1,694,089 issuing to M. Wright on Dec. 4, 1928 discloses a register duct cover which is removed to gain access to a filter.

U.S. Pat. No. 1,429,811 issuing to Tynan on Sep. 19, 1922, discloses a register attachment which includes a casing, a pane, and screens which are sized to fit an air duct.

### BRIEF SUMMARY OF THE INVENTION

Thus, what is needed is a filter housing for mounting upon a register, diffuser, or return air grill, which is adapted to slidably receive an air filter therein, without requiring the air filter housing to be removed from the wall, floor or ceiling surrounding an air duct. The filter housing mounts externally on the grill.

Since the size of air ducts in homes and offices vary widely, what is also needed is an air filter housing that is adaptable to vary in size in at least one dimension, to reduce the quantity of air filters and air filter housing required to accommodate a wide variety of air duct types and sizes.

What is also needed is an air filter housing for mounting to a register, diffuser or return air grill, which does not require removal of the air filter housing from the grill, to remove, clean or replace the air filter.

What is also needed, is an air filter housing adapted to receive a variety of air filters which are custom designed to remove specific pollutants from the air, to accommodate the needs of asthma and allergy sufferers, and to improve the air quality in a home or office. A wide variety of pollutants may be removed from the air stream, including dust, dirt, mites, mite feces, bacteria, spores, allergens, chemical orders, and general air born pollutants found in residential, commercial and industrial air duct systems. The ease of periodic replacement of air filters month by month, or season by season, is essential to the needs of such users.

The front of the filter housing should be aesthetically pleasing, and may be decoratively designed to fit a variety of home and office decor. An open face design is preferred, to permit maximum air flow through the air filter.

The air filter housing can be manufactured using a high impact plastic material in a selected color, to match or contrast with the interior d6cor. Alternately, the filter housing can be translucent or transparent to suit user preference.

The present invention does not impede the operation of the register, diffuser, or return air grill. The register control, typically a slidable lever used to adjust the air flow through the register, is left uncovered by the air filter, or the air filter may be slidably moved to provide unrestricted manual adjustment of the register control.

### BRIEF DESCRIPTION OF THE DRAWINGS

The above mentioned and other features and objects of the invention and the manner of obtaining them will become more apparent and the invention itself will be better understood by reference to the following description of embodiments of the invention, when taken in conjunction with the accompanying drawings, wherein:

FIG. 1 is a perspective view of a filter housing according to the present invention, having a fixed length and width.

FIG. 2A is a front elevational view of the filter housing of FIG. 1.

FIG. 2B is a front elevational view of the filter housing utilizing a honeycomb design having a fixed length and width.

FIG. 3 is a side elevational view of the filter housing of FIG. 1.

FIG. 4 is a first end elevation view of the filter housing of FIG. 1, showing an opening provided in the first side to slidably receive and position an air filter within the filter housing, without removing the filter housing from the air duct.

FIG. 5 is an end elevation view showing the second end of the filter housing of FIG. 1.

FIG. 6 is a top elevational view of the filter housing of FIG. 1, showing the air filter positioned for insertion into the opening provided in the filter housing.

FIG. 7 is a cross sectional view of the filter housing, showing the filter installed within the filter housing.

FIG. 8 is a front elevational view of an adjustable length filter housing utilizing a honeycomb design, which is expandable in one direction to accommodate a variety of grill sizes.

FIG. 9 is a cross-sectional view of the air filter housing taken along lines 9-9 in FIG. 8, showing a first end slidably received in relation to a second end to adjustably fit the air filter housing to a variety of air duct sizes.

FIG. 10A is a bottom view of the filter housing showing a releasable securement means to secure the filter housing to an opening in an air duct.

FIG. 10B is a partial perspective view of a tab positioned on a lower portion to be received and secured in a selected one of several openings located on an upper portion of the adjustable length grill shown in FIG. 8.

FIG. 11 is a first end elevation view of a further embodiment of a filter housing similar to FIG. 1 and wherein like numerals indicate like parts, showing an opening provided in the first side to slidably receive and position an air filter within the filter housing, without removing the filter housing from the air duct.

FIG. 12 is an end elevational view of a further embodiment of a filter which is similar to the filter of FIG. 7, and having two apertures therein, for use with the filter housing of FIG. 11.

FIG. 13 is an end elevational view of the filter of FIG. 12, for use with the filter housing of FIG. 11.

FIG. 14 is an assembly view of a top elevational view of the filter housing of FIG. 11, which is similar to FIG. 1 and wherein like numerals indicate like parts, showing the air filter positioned for insertion into the opening provided in the filter housing.

### DETAILED DESCRIPTION OF THE INVENTION

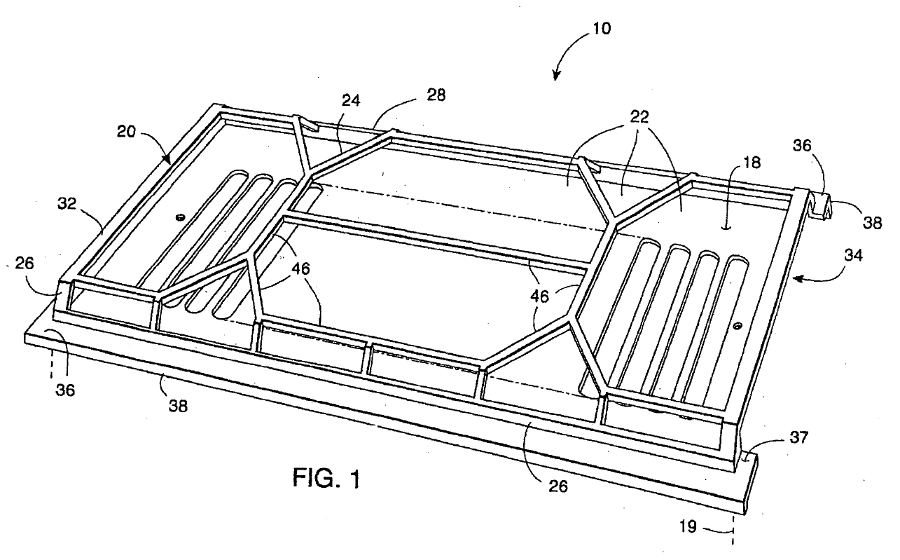

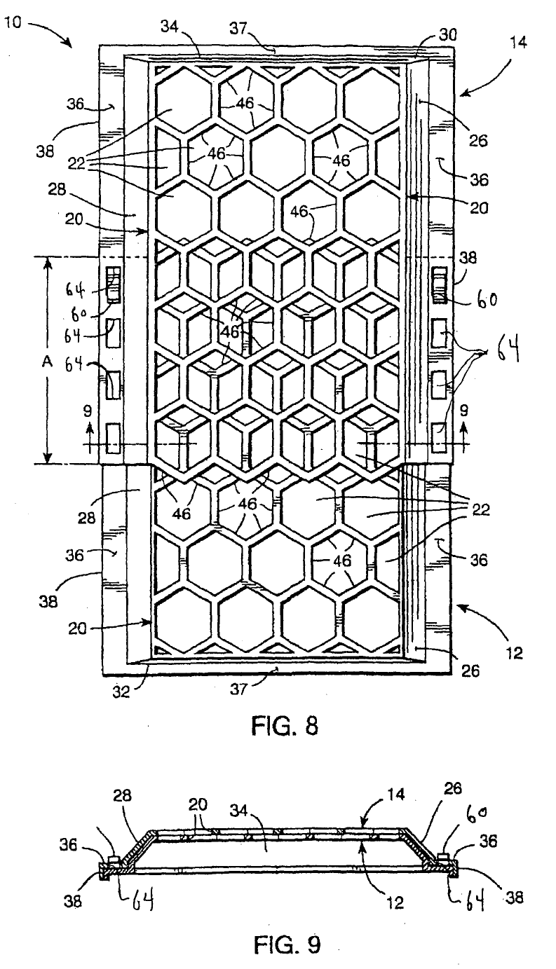

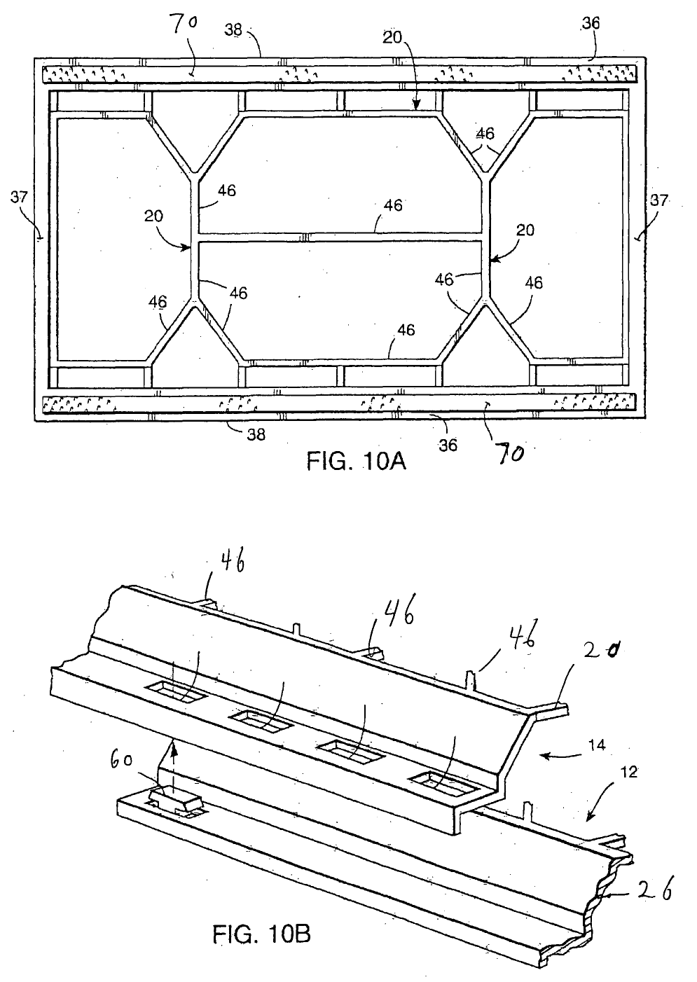

FIG. 1 through FIG. 7 and FIG. 10A show details of an air filter housing 10 having a fixed length and width designed to fit a specific air duct size. FIG. 8, FIG. 9, and FIG. 10B show details of an adjustably sized air filter housing 10, having a first side portion 12 slidably received in relation to a second side portion 14, to vary the length of the air filter housing 10 at assembly, in order to adapt the air filter housing to fit a variety of air duct sizes.

As shown in FIG. 1, the air filter housing 10 includes a raised top portion 20 having a plurality of shaped apertures 22 forming a design pattern 24 thereon. The shaped apertures 22 preferably extend along the top portion 20 and first and second side portions 26, 28. It is also within the scope of this disclosure to limit the shaped apertures 22 to the raised top portion 20 only.

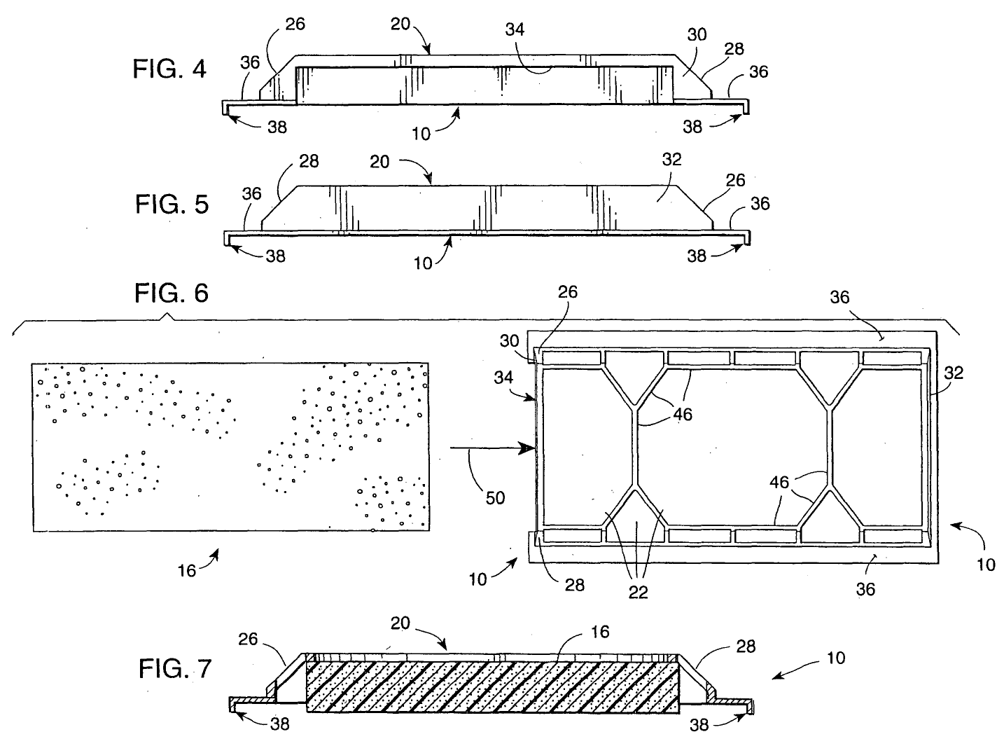

A first end portion 32 has an elongated filter aperture 34 sized to slidably receive an air filter 16 therethrough, as shown in FIG. 4. A second end portion 32 may also include shaped apertures 22, or may be of solid construction, to suit manufacturing preference, as shown in FIG. 5. While the elongated filter aperture 34 is shown positioned in the first end portion 30, it is well within the scope of this disclosure, to position the elongated filter aperture 34 on either the first or second side portions 26, 28 or first or second end portions 30, 32 to suit manufacturing preference, and such variations are intended to fall within the scope of this disclosure, and the following claims.

The first and second side portions 26, 28 are preferably inclined from the raised top portion 20 to a fiat side flange portion 36, which extends outwardly from the respective first and second side portions 28, 30 to cover a new or existing grill 18, which in turn covers an air duct 19 opening. The fiat flange end portions 37 preferably also extend from the first and second end portions 30, 32 to entirely cover the outer periphery of the new or existing grill 18.

Preferably, a flange lip 38 extends from the fiat flange side portion 36 at least along the first and second side portions 26, 28 to cover the thickness of the new or existing grill 18, along the sides of the grill 18. The flange lip 38 may also extend from the fiat flange end portions 37 along the first and second end portions 30, 32, to cover the thickness of the ends of the new or existing grill 18.

A suitable mounting fastener (not shown) may be used to secure the filter housing 10 to the grill 18. A mounting aperture (not shown) may optionally be provided for alignment with a mounting aperture in the grill 18, for example. Thus, no additional drilling is required to mount the air filter housing 10 to a new or existing grill 18. The mounting bracket may extend inwardly from the first and second end portions 26, 28, and the mounting brackets may entirely covered by the air filter 18, when the air filter 18 is mounted in the air filter housing 10. Thus, no mounting fastener is visible when the air filter 18 is positioned within the air filter housing 10, yet easy access to the mounting fastener is provided, when the air filter 18 is removed.

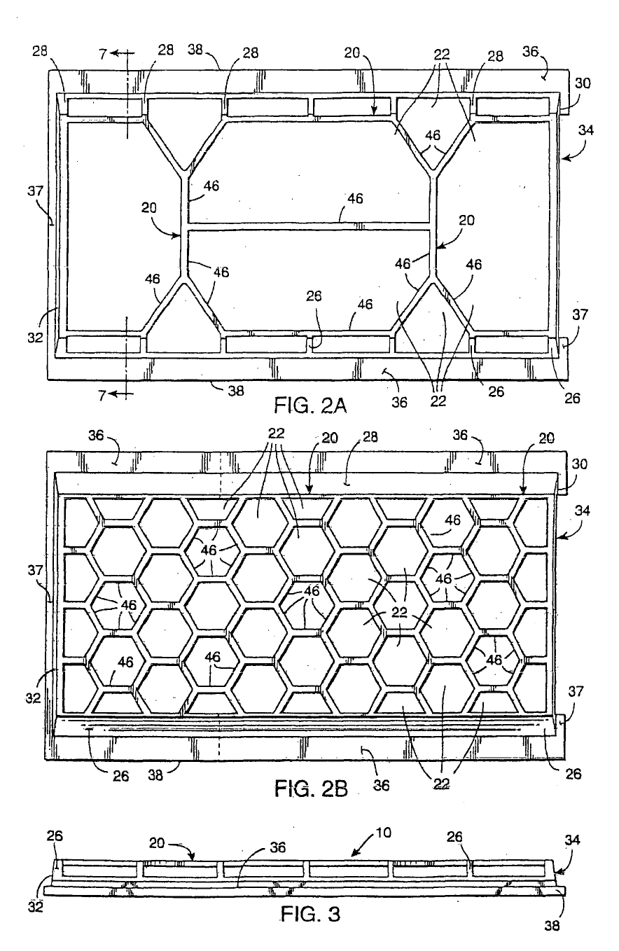

As seen in FIG. 1, the air filter housing 10 is positioned over a new or existing grill 18. FIG. 2 is a front elevation view of the air filter housing 10. The shaped apertures 22 are formed by a plurality of ribs 46, which form the design pattern 24 shown in FIG. 2. It is well within the scope of one of average skill in this art, to position straight or curved ribs to form any number of design patterns 24 on the raised top portion 20 if the air filter housing 10, and all such design patterns 24 are intended to fall within the scope of this disclosure, and the following claims. FIG. 2B shows a plurality of honeycomb shaped apertures 22 formed by the plurality of ribs 46, in a second example embodiment of the air filter housing 10.

The plurality of ribs 46 are positioned to retain an air filter 16 beneath the raised top portion 20, while preferably providing maximum air flow through the air filter 16. The ribs 46 may be curved, angled, or straight, to suit design and manufacturing preference.

This invention provides for visible inspection of the air filter 16, without requiring removal of the air filter 16 from the air filter housing 10. When the air filter 16 requires changing, the air filter may 16 be removed through the filter aperture 34, without removing the air filter housing 10.

FIG. 3 is a side elevation view of the first side portion 26 of the air filter housing 10 shown in FIG. 2A. In this view, the shaped apertures 22 extend along the first side portion 26. The height of the first side portion 26 between the raised top portion 20 and the surrounding flange 36 is selected to enable the air filter 16 to be slidably received therein. The second side portion 28 is preferably similar in size and shape to the first side portion 26, and thus is not separately illustrated herein.

FIG. 4 is an end view of the first end portion 30, showing the elongated filter aperture 34 positioned therein. The elongated filter aperture 34 is sized to slidably receive an air filter 16 therethrough. The depending flange lip 38 is also clearly shown in FIG. 4. The depending flange lip 38 is positioned to cover the thickness of the new or existing grill 18.

FIG. 5 is an end view of the second end portion 32. In this view, the second end portion 32 is of solid construction. However, it is within the scope of this disclosure to extend the shaped apertures 22 to extend along the second end portion 32.

FIG. 6 is an exploded view of the air filter housing 10, with the air filter 16 positioned to be slidably received through the elongated filter aperture 34, as shown by arrow 50. The elongated filter aperture 34 enables the user to slidably position an air filter 16 within the filter housing 10 without removing and replacing the air filter housing 10 over the air duct. This greatly simplifies the removal and replacement of an air filter 16, which must be done periodically to maintain the efficiency of the air filter 16. Depending upon the type of air filter 16 used, removal and replacement should may be required monthly, to effectively filter the air. Current air filter designs require the user to unscrew the grill 18 to position an air filter within the air duct. Since there are numerous air ducts in a conventional building, this requires considerable time and effort.

Applicant's invention greatly simplifies the removal and installation of an air filter 16 by slidably receiving the air filter 16 through the air filter aperture 34 located at one end of the air filter housing 10. The air filter housing 10 is not removed from the air duct to replace the air filter 16, thus no tools are required for replacing the air filter 16, and the time required for changing air filters 16 is greatly reduced.

FIG. 7 is a cross sectional view of the air filter housing 10 taken along lines 7-7 in FIG. 2. As shown in FIG. 7, the air filter 16 is positioned within the air filter housing 10, to filter the air passing through the new or existing grill 18.

FIG. 8 is a front elevation view of the expandable air filter housing 10, showing the first housing side 12 and the second housing side 14 slidably positioned in relation to each other to cover various lengths of new or existing grill 18. Arrows A show the adjustable range of the first and second housing sides 12, 14. Preferably the adjustable range is plus or minus several inches, to accommodate, by way of example, a grill size of ten to fourteen inches. This reduces the numerous sizes of air filter housings 10 required, simplifying the stocking and displaying of multiple air filter housings.

As shown in a cross sectional view in FIG. 9, the first housing side 12 is sized to be slidably received in relation to the second housing side 14. This requires the first housing side 14 to be slightly larger than the second housing side 12. Of course, the secQnd housing side 14 could be adapted to be slidably received within the first housing side 12, and all such adaptations are intended to fall within the scope of this disclosure, and the following claims.

Preferably, the first housing side 12 and the second housing side 14 slidably expand to cover a grill at least 14 inches in length, and further slidably retract to cover a grill ten inches or less in length.

As shown in FIG. 9 and FIG. 10B, a tab 60 may be positioned on the first housing side 12. The tab 60 is received in a selected tab aperture 64 positioned through the second housing side 14. The tab 60 includes a tip 66 which slidably engages the fiat side flange portion 36 at the edge of tab aperture 64 to retain the second housing side 12 in one of the selected tab apertures 64 positioned in spaced alignment on the flat side flange portion 36 of the second housing side 14. This allows the air filter housing 10 to incrementally expand or contract to suit an existing grill 18 covering an existing air duct opening.

As shown in FIG. 10A, the air duct housing may be secured to the grill 18 with a suitable fastening means 70, such as a hook and loop fastener, or two sided adhesive.

The filter housing 10 is sized to be externally mounted upon a new or existing grill or register 18, which is typically secured about an air duct 19, located in a floor, wall or ceiling (not shown). The new or existing grill or register 18 serves to retain the air filter 16 between the register 18 and the raised top portion 20 of the air filter housing 10.

The air filter housing 10 is preferably sized to hold air filters 16 of varying types and density, to suit the needs of the user. The filter housing 10 is preferably affixed to the front face or grill 18 of a wall register, floor diffuser, gravity register, or return air grill, to accommodate most types of air ducts 19 which circulate air within a room, home or office. Such air ducts 19 are typically rectangular or square in shape, and come in a variety of lengths and widths. The air filter housing 10 disclosed herein, slidably receives the air filter 16 from one of the sides 26, 28 or ends 30, 32 of the housing 10, eliminating the need to pivot or remove the air filter cover or housing 10 to access the air filter 16, as disclosed in the prior art.

The length of most residential and office type air register ducts 19 varies from ten inches to fourteen inches in length. The width of most air register ducts 19 varies from six inches to ten inches in width. While individual filter housings 10 may be made to suit each size and shape of air register duct 19. This invention allows several sizes to be adapted to fit most air duct 19 sizes.

The present air filter housing 10 is externally secured to the air duct grill 18. Thus, the width of the grill 18 may be larger than the size of the air duct 19. For example, an eight inch width of air filter housing 10 can easily accommodate air duct 19 width having a size of six inches to eight inches. Likewise, a ten inch width of air filter housing 10 can easily accommodate air duct 19 sizes of eight inches to ten inches in width.

In one example embodiment, air ducts 19 having a width of six inches to ten inches, and a length of ten inches to fourteen inches may be accommodated with just one or two sizes of air filter housing 10. Applicant's invention may alternately be adapted to other widths and lengths to suit new and existing air duct 19 sizes, and such adaptations are intended to fall within the scope of this disclosure, and the following claims.

The length of the air filter housing 10 may be adjustably sized as shown in FIG. 8 and FIG. 9, to accommodate a variety of air duct 19 lengths. In this embodiment, the first side portion 12 is slidably received in relation to the second side portion 14, to adjust the air filter housing 10 to a multiple of lengths of existing air duct 19 sizes. For example, where the first side portion 12 and the second side portion 14 are each greater than one-half the length of air duct 19, the air filter housing 10 can expand to cover the air duct 19 opening. Since most air duct 19 openings in a home or office are sized from ten to fourteen inches in length, all such sizes can be accommodated with an air filter housing 10 which slidably expands to cover the fourteen inch air duct 19 size, and slidably retracts to cover the ten inch air duct 19 size. The adjustment length is shown in FIG. 8, as arrow A.

This greatly simplifies the number and sizes of air filter housings 10 required to accommodate most home and office air duct 19 sizes. The slidable air duct housing 10 disclosed herein, further simplifies the stocking of air filters 16. The width of the air filters 16 can be standardized, and the length of the air filters 16 can be limited to a few specific lengths, selected to be from ten inches to fourteen inches in length.

Where air filters 16 are located in the air duct 19 behind the grill 18, the air filters must be sized to be closely received within the air duct 19. As previously mentioned, this greatly increases the quantity of sizes required to fit a variety of homes or offices.

Applicant's invention mounts the air filter housing 10 externally of the grill 18, allowing the air filter 16 to be somewhat larger than the opening of the air duct 19. This greatly reduces the quantity of sizes required to fit most air ducts 19, thus reducing stocking costs, shelf space, transportation costs, and consumer confusion as to which size to purchase.

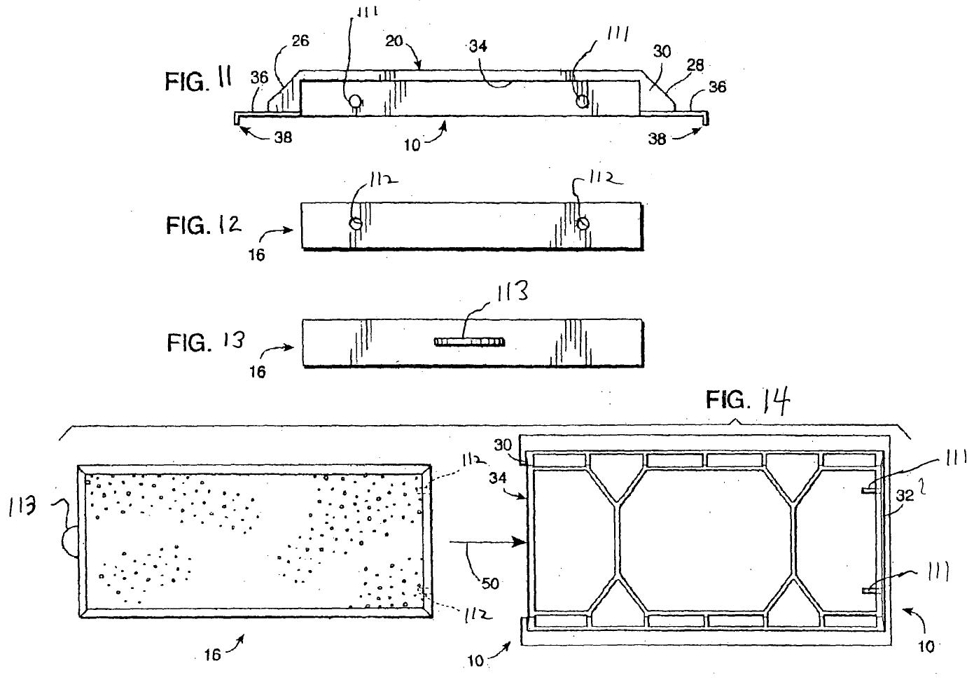

FIG. 11 is a first end elevation view of a further embodiment of a filter housing similar to FIG. 1 and wherein like numerals indicate like parts, showing an opening provided in the first side to slidably receive and position an air filter within the filter housing, without removing the filter housing from the air duct. Inasmuch as like numerals indicate like parts with the previous embodiments, a description of those like elements is omitted. FIG. 11 additionally includes a pair of pins 111, 111 which are adapted to be received in corresponding bores in a filter or filter element 16 (shown in FIGS. 12 and 13) which is to be inserted into the filter housing.

FIG. 12 is an end elevational view of a further embodiment of a filter which is similar to the filter of FIG. 7, and having two apertures therein, for use with the filter housing of FIG. 11. Inasmuch as like numerals indicate like parts with the previous embodiments, a description of those like elements is omitted. The filter 16 further incorporates a pair of elongated apertures 112, 112 which are adapted to receive the pins 111, 111 of FIG. 11. This permits a positive, secure locking or mating engagement between the filter housing and the filter 16, so that the filter 16 does not vibrate, rattle, or come loose during use.

FIG. 13 is an end elevational view of the filter of FIG. 12, for use with the filter housing of FIG. 11. A tab 113 is visible in this view, for permitting handling of the filter 16 and may include a securement means such as a screw, pin, or other fastener for securement of the filter 16 to a register or to the filter housing.

FIG. 14 is an assembly view of a top elevational view of the filter housing of FIG. 11, which is similar to FIG. 1 and wherein like numerals indicate like parts, showing the air filter positioned for insertion into the opening provided in the filter housing. The pins 111, 111 and the apertures 112, 112 are also shown in this view.

Thus, while a specific embodiment of the air filter housing has been disclosed and described for purposes of illustration, the protection afforded by any patent which issues upon the application is not strictly limited to the disclosed embodiment, but rather extends to all structures and arrangements which fall faidy within the scope of the following claims.

What is claimed is:

1. A filter housing for receiving a filter, comprising:
a filter housing having a raised top portion having a plurality of shaped apertures, a first end portion adapted to slidably receive an air filter therein, a second end portion opposite said first end portion, and two side portions connecting said first and second ends.

2. A filter housing as claimed in claim 1, where the shaped apertures extend along the top portion and the first and second side portions.

3. A filter housing as claimed in claim 1, where the second end portion also includes shaped apertures.

4. A filter housing for receiving a filter, comprising:
a filter housing having a raised top portion having a plurality of shaped apertures, a first end portion adapted to slidably receive an air filter therein, a second end portion opposite said first end portion, and two side portions connecting said first and second ends; wherein said two side portions are adjustable in length so as to vary the length of the air filter housing at assembly, in order to adapt the air filter housing to fit a variety of air duct sizes.

5. A filter housing as claimed in claim 4, where the shaped apertures extend along the top portion and the first and second side portions.

6. A filter housing as claimed in claim 4, where the second end portion also includes shaped apertures.

7. A filter housing as claimed in claim 4, wherein said two side portions include telescoping means having two parts for slidably varying the lengths of the two side portions.

8. A filter housing for receiving a filter and an air filter in combination, comprising:
a filter housing having a raised top portion having a plurality of shaped apertures, a first end portion adapted to slidably receive an air filter therein, a second end portion opposite said first end portion, and two side portions connecting said first and second ends;
an air filter element having an end portion which includes two apertures therein; and
wherein said second end portion of said filter housing having a pair of projecting pins adapted for engagement with apertures in the air filter element.

9. A filter housing as claimed in claim 8, where the shaped apertures extend along the top portion and the first and second side portions.

10. A filter housing as claimed in claim 8, where the second end portion also includes shaped apertures.
